(19) United States
(12) Patent Application Publication
(10) Pub. No.: US 2007/0266307 A1
(43) Pub. Date: Nov. 15, 2007

(54) Auto-layout of shapes

(75) Inventors: Nagalinga Durga Prasad Sripathi Panditharadhya, Redmond, WA (US); John Edward Churchill, Monroe, WA (US); Udaya Kumar Bhaskara, Redmond, WA (US)

Correspondence Address: MICROSOFT CORPORATION, ONE MICROSOFT WAY, REDMOND, WA, 98052-6399, US

(73) Assignee: Microsoft Corporation Microsoft Patent Group, Redmond, WA (US)

(21) Appl. No.: 11/434,039

(22) Filed: May 15, 2006

(51) Int. Cl. G06F 17/00; G06F 15/00

(52) U.S. Cl. 715/502; 715/517

(57) ABSTRACT

Various technologies and techniques are disclosed that automatically layout components/shapes on a design surface. The system receives input from a user to add components to the design surface. At an appropriate time, the system initiates an auto-layout process. The auto-layout process maps each shape in a particular set to a two-dimensional grid and uses the two-dimensional grid to assign an X and Y value to each shape. For any shape having a new X and Y value, the position of the shape is adjusted on the design surface. The system provides a visual indicator on the design surface to indicate that component positions are being adjusted. The system provides an undo feature to allow the user to undo the auto-layout process when desired.

### BACKGROUND

There are numerous types of visual designers on the market today that allow users to create sophisticated diagrams, business process integrations, user interfaces, and so on. These visual designers allow users to drag and drop components, such as components and/or shapes, onto a design surface, and to manually arrange the components as desired. Some visual designers allow a user to select a particular set of components and specify certain commands to apply to those components, such as to align them with the same left side, or to apply the same font size to them.

The user may frequently add a new component to the design surface, and then have to adjust many of the existing components to make the layout more readable or better optimized to illustrate the particular scenario. The manual task of adjusting numerous components to make room for the one just added is extremely tedious for the user.

### SUMMARY

Various technologies and techniques are disclosed that automatically layout components/shapes on a design surface. The system receives input from a user to add components to the design surface. At an appropriate time, the system initiates an auto-layout process. The auto-layout process can be initiated as each component is drawn on the design surface, upon user selection to apply the process to an existing drawing, or at another specified time. The auto-layout process maps each shape in a particular set to a two-dimensional grid and uses the two-dimensional grid to assign an X and Y value to each shape. For any shape having a new X and Y value, the position of the shape is adjusted on the design surface. The system provides a visual indicator on the design surface to indicate that component positions are being adjusted. The system provides an undo feature to allow the user to undo the auto-layout process when desired.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of an auto-layout application of one implementation operating on the computer system of FIG. 1.

FIG. 3 is a high-level process flow diagram for one implementation of the system of FIG. 1.

FIG. 4 is a process flow diagram for one implementation of the system of FIG. 1 illustrating the stages involved in automatically laying out components/shapes on a design surface.

FIG. 5 is a process flow diagram for one implementation of the system of FIG. 1 illustrating the stages involved in performing pre-processing steps as part of the auto-layout process.

FIG. 6 is a process flow diagram for one implementation of the system of FIG. 1 illustrating the stages involved in a more detailed process for automatically laying out components/shapes on a design surface.

FIG. 7 is a process flow for one implementation of the system of FIG. 1 that illustrates the stages involved in mapping the components/shapes to a two-dimensional grid.

FIG. 8 is a process flow for one implementation of the system of FIG. 1 that illustrates the stages involved in determining the placement positions for the components/shapes.

FIG. 9 is a process flow for one implementation of the system of FIG. 1 that illustrates calculating a Y position for a particular component/shape.

FIG. 10 is a process flow for one implementation of the system of FIG. 1 that illustrates deleting a shape from a relationship set.

FIG. 11 is a process flow for one implementation of the system of FIG. 1 that illustrates adding a new shape or link.

FIG. 12 is a process flow for one implementation of the system of FIG. 1 that illustrates animating changes made on the design surface during the auto-layout process.

FIG. 13 is a simulated screen for one implementation of the system of FIG. 1 that illustrates a sample visual designer with a drawing that uses the auto-layout process.

FIG. 14 is a diagram for one implementation of the system of FIG. 1 that illustrates calculating height, fanout, and offset values for each component/shape to help determine new positions.

FIG. 15 is a logical diagram for one implementation of the system of FIG. 1 that illustrates height and offset values for a particular component/shape.

FIG. 16 is a logical diagram for one implementation of the system of FIG. 1 that illustrates a sample two-dimensional grid filled with the components/shapes from FIG. 15 upon executing the auto-layout process.

FIG. 17 is a logical diagram for one implementation of the system of FIG. 1 that illustrates height and offset values for multiple shapes present together on a design surface.

FIG. 18 is a logical diagram for one implementation of the system of FIG. 1 that illustrates using the offset and height values to determine shape position.

FIG. 19 is a portion of a simulated screen for one implementation of the system of FIG. 1 that illustrates a diagram adjusted during the auto-layout process.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application that automatically lays out components/shapes on a design surface, but the system also serves other purposes in addition to these. In one implementation, one or more of the techniques described herein can be implemented as features within a process integration program such as MICROSOFT® BizTalk, MICROSOFT® Office VISIO®, or from any other type of program or service that works with business processes, diagrams, or other visual designs. In another implementation, one or more of the techniques described herein are implemented as features with other applications that deal with components, clauses, and/or shapes drawn on a design surface.

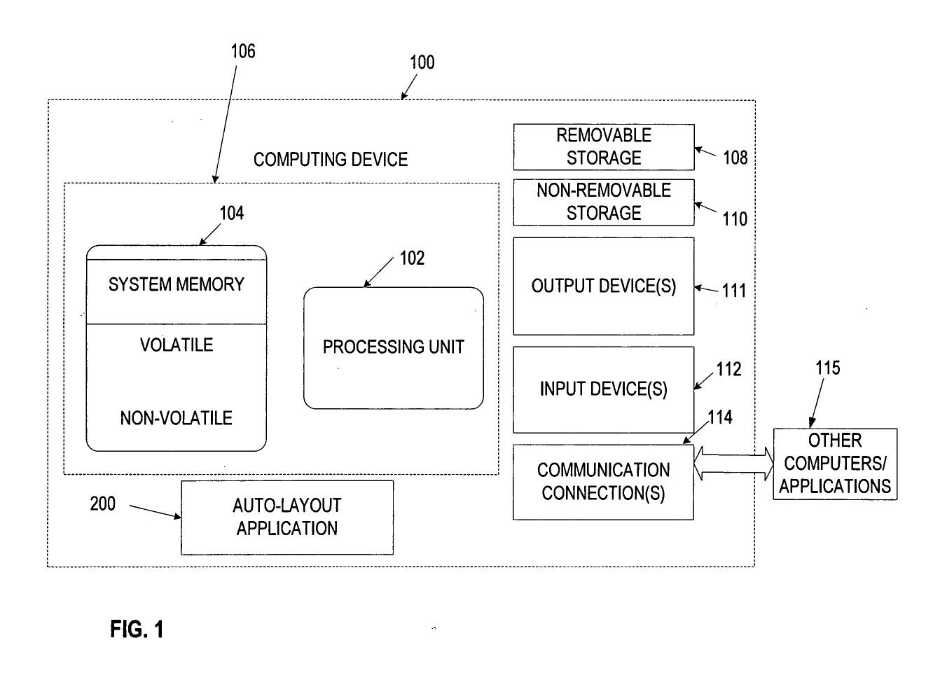

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

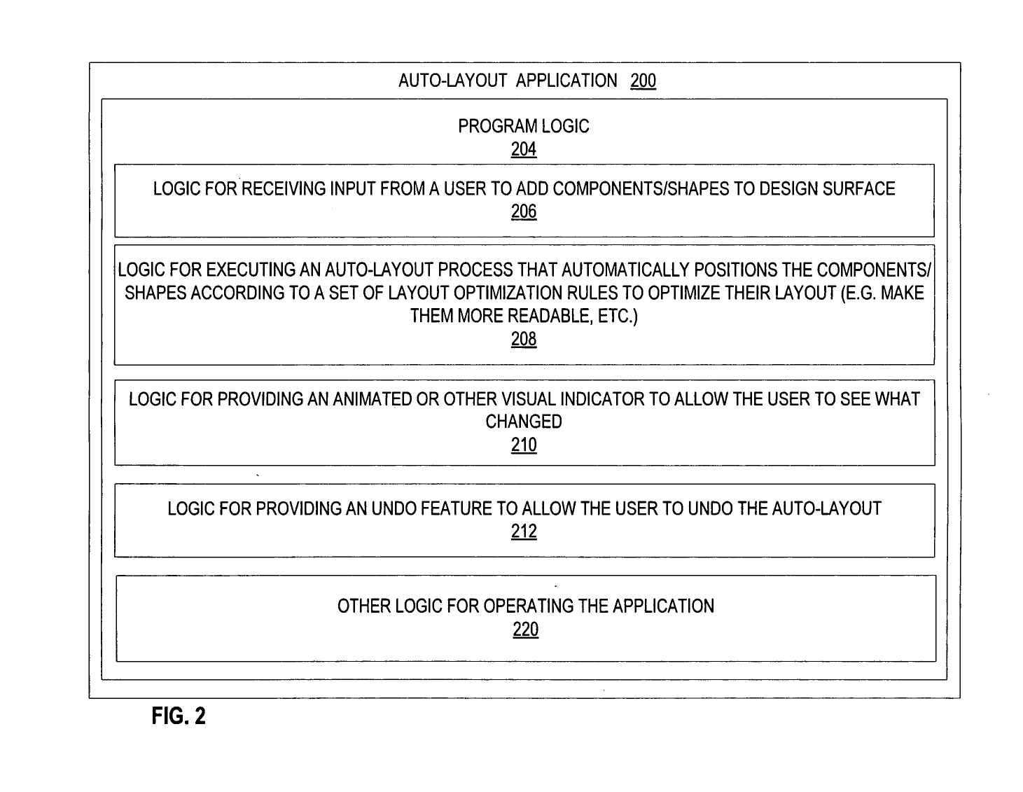

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes auto-layout application 200. Auto-layout application 200 will be described in further detail in FIG. 2.

Turning now to FIG. 2 with continued reference to FIG. 1, an auto-layout application 200 operating on computing device 100 is illustrated. Auto-layout application 200 is one of the application programs that reside on computing device 100. However, it will be understood that auto-layout application 200 can alternatively or additionally be embodied as computer-executable instructions on one or more computers and/or in different variations than shown on FIG. 1. Alternatively or additionally, one or more parts of auto-layout application 200 can be part of system memory 104, on other computers and/or applications 115, or other such variations as would occur to one in the computer software art.

Auto-layout application 200 includes program logic 204, which is responsible for carrying out some or all of the techniques described herein. Program logic 204 includes logic for receiving input from a user to add components/shapes to design surface 206; logic for executing an auto-layout process that automatically positions the components/shapes according to a set of layout optimization rules to optimize their layout (e.g. make them more readable, etc.) 208; logic for providing an animated or other visual indicator to allow the user to see what changed 210; logic for providing an undo feature to allow the user to undo the auto-layout 212; and other logic for operating the application 220. In one implementation, program logic 204 is operable to be called programmatically from another program, such as using a single call to a procedure in program logic 204.

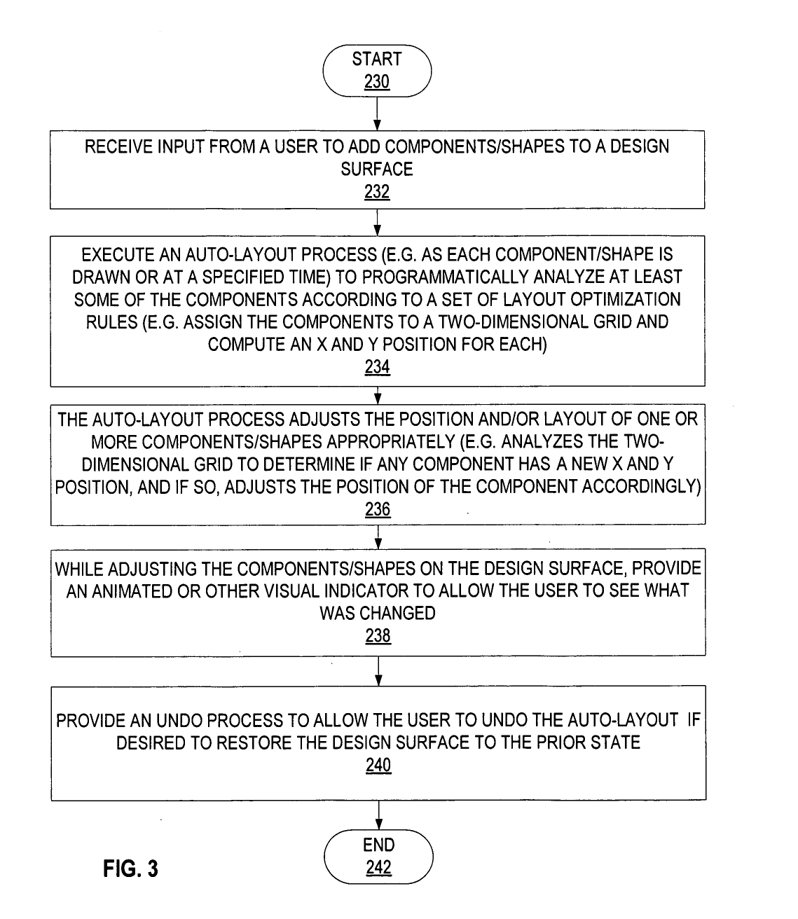

Turning now to FIGS. 3-12 with continued reference to FIGS. 1-2, the stages for implementing one or more implementations of auto-layout application 200 are described in further detail. FIG. 3 is a high level process flow diagram for auto-layout application 200. In one form, the process of FIG. 3 is at least partially implemented in the operating logic of computing device 100.

The procedure begins at start point 230 with receiving input from a user to add components/shapes to design surface (stage 232). The system executes an auto-layout process (e.g. as each component/shape is drawn or at a specified time) to programmatically analyze at least some of the components according to a set of layout optimization rules (e.g. assigns the components to a two-dimensional grid and computes an x and y position for each) (stage 234). The auto-layout process adjusts the position and/or layout of one or more components/shapes appropriately (e.g. analyzes the two-dimensional grid to determine if any component has a new X and Y position, and if so, adjusts the position of the component accordingly) (stage 236). While adjusting the components/shapes on the design surface, the system provides an animated or other visual indicator to allow the user to see what changed (stage 238). The system also provides an undo process to allow the user to undo the auto-layout if desired to restore the design surface to the prior state (stage 240). The process ends at end point 242.

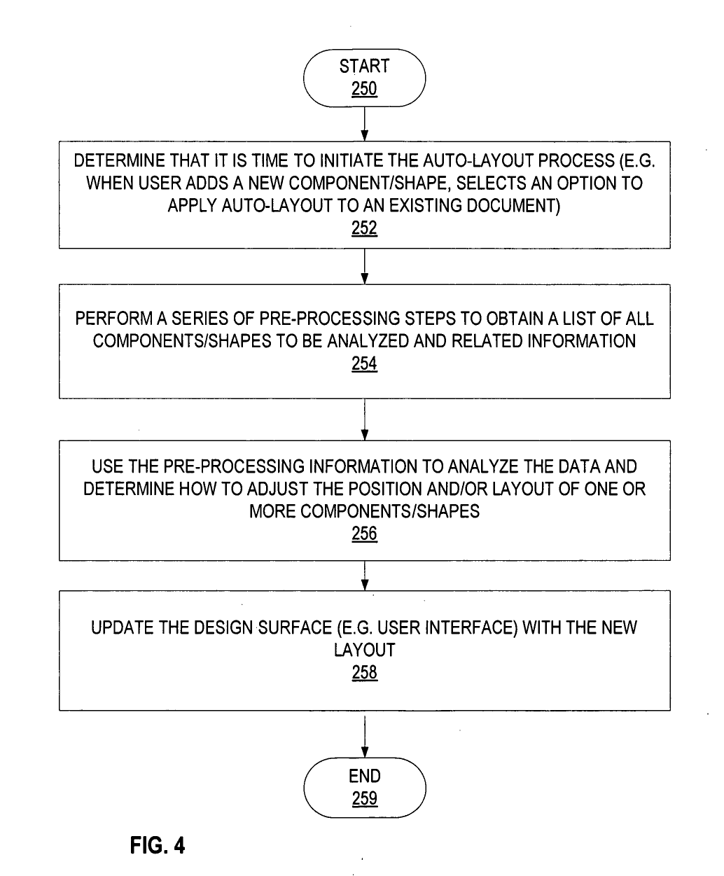

FIG. 4 illustrates one implementation of the stages involved in automatically laying out components/shapes on a design surface. In one form, the process of FIG. 4 is at least partially implemented in the operating logic of computing device 100. The procedure begins at start point 270 with determining that it is time to initiate the auto-layout process (e.g. when user adds a new component/shape, selects an option to apply auto-layout to an existing document, etc.) (stage 252). The system performs a series of pre-processing steps to obtain a list of all components/shapes to be analyzed and related information (stage 254). The system uses the pre-processing information to analyze the data and determine how to adjust the positing and/or layout of one or more components/shapes (stage 256). The system updates the design surface (e.g. user interface) with the new layout (stage 258). The process ends at end point 259.

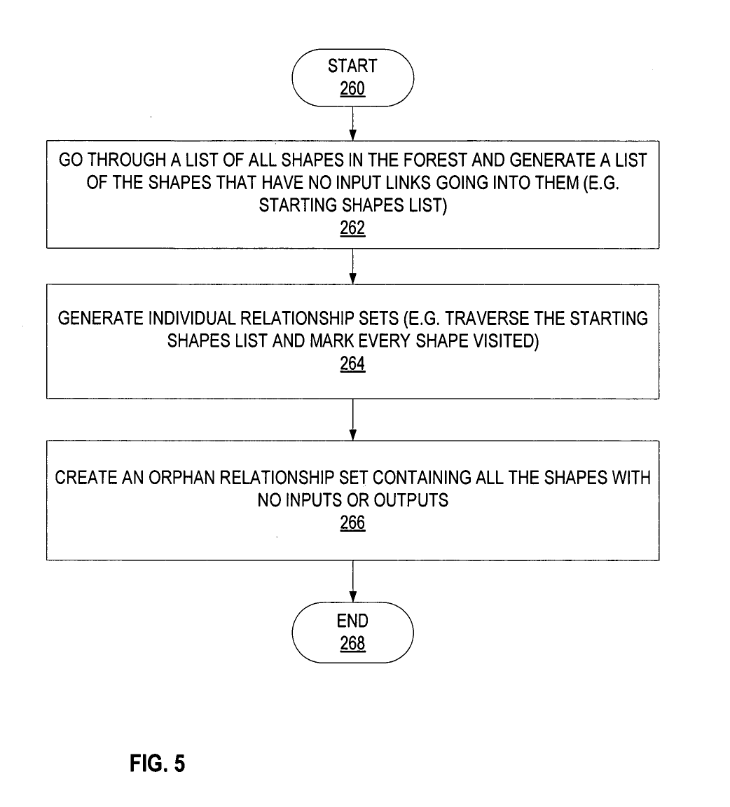

FIG. 5 illustrates one implementation of the stages involved in performing pre-processing steps as part of the auto-layout process. In one form, the process of FIG. 5 is at least partially implemented in the operating logic of computing device 100. The procedure begins at start point 260 with going through a list of all shapes in the forest and generating a list of the shapes that have no input links going into them (e.g. starting shapes list) (stage 262). The system generates individual relationship sets (e.g. traverses the starting shapes list and marks every shape visited) (stage 264). In one implementation, a relationship set is defined as a container of minimum set of shapes such that there are no outgoing or incoming links from this relationship set to the outside world and vice versa. In other words, every shape in the set is reachable from any other shape within the set if you can traverse through the connecting links (ignoring the directions on the links). In one implementation, the system treats the relationship set as one unit within which the shapes are laid out. An orphan relationship set is created that contains all the shapes with no inputs or outputs (stage 266). The process ends at end point 268.

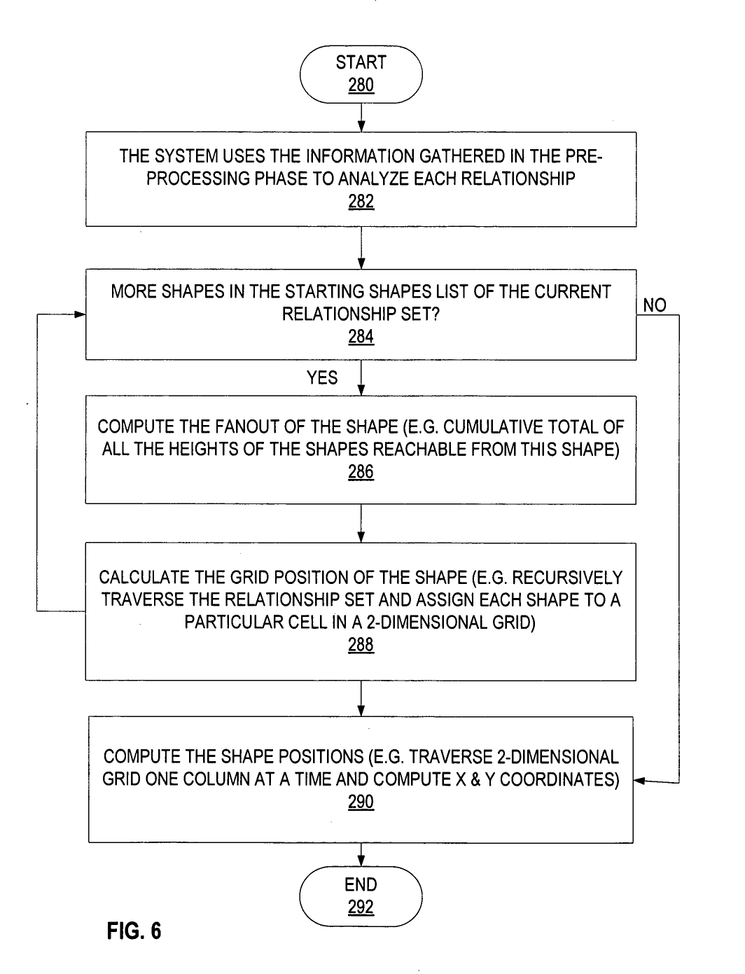

FIG. 6 illustrates one implementation of the stages involved in a more detailed process for automatically laying out components/shapes on a design surface. In one form, the process of FIG. 6 is at least partially implemented in the operating logic of computing device 100. The procedure begins at start point 280 with the system using the information gathered in the pre-processing phase to analyze each relationship (stage 282). For each shape in the current relationship set (decision point 284), the system performs various computations. The system computes the fanout of the shape (stage 286). In one implementation, the fanout of a shape is defined as the cumulative total of all the heights of the shapes reachable from this shape (in forward direction).

The system calculates the grid position of the shape (e.g. recursively traverses the relationship set and assigns each shape to a particular cell in a two-dimensional grid) (stage 288). The system then computes the shape positions (e.g. traverses the two-dimensional grid one column at a time and computes X & Y coordinates for the shape) (stage 290). The process ends at end point 292.

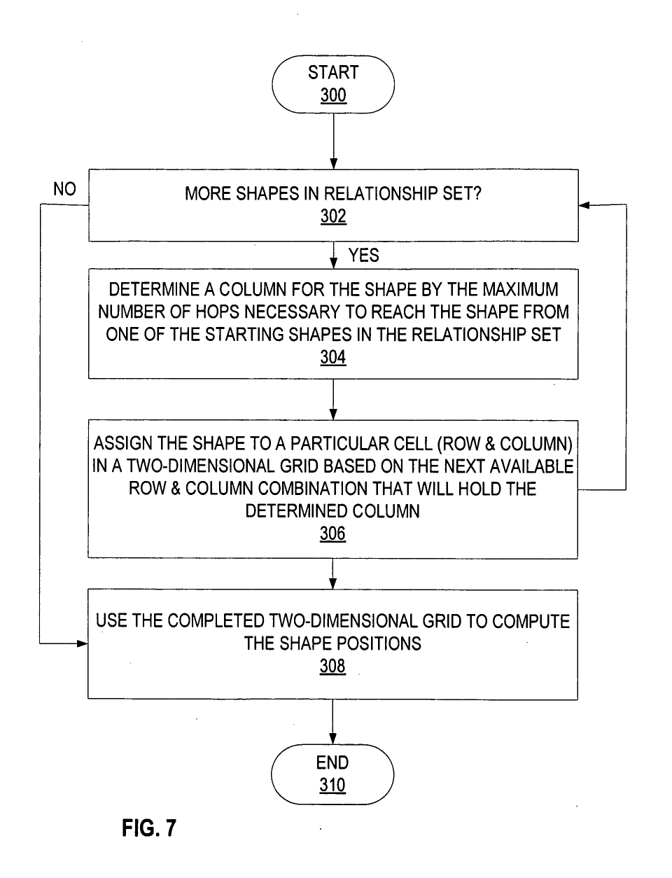

FIG. 7 illustrates one implementation of the stages involved in mapping the shapes to a two-dimensional grid. In one form, the process of FIG. 7 is at least partially implemented in the operating logic of computing device 100. The procedure begins at start point 300 with performing a series of steps for each shape in the relationship set (decision point 302). The system determines a column for the shape by the maximum number of hops necessary to reach the shape from one of the starting shapes in the relationship set (stage 304). The system assigns the shape to a particular cell (row & column) in a two-dimensional grid based on the next available row and column combination that will hold the determined column (stage 306). The system then uses the completed two-dimensional grid to compute the shape positions (stage 308). The process ends at end point 310.

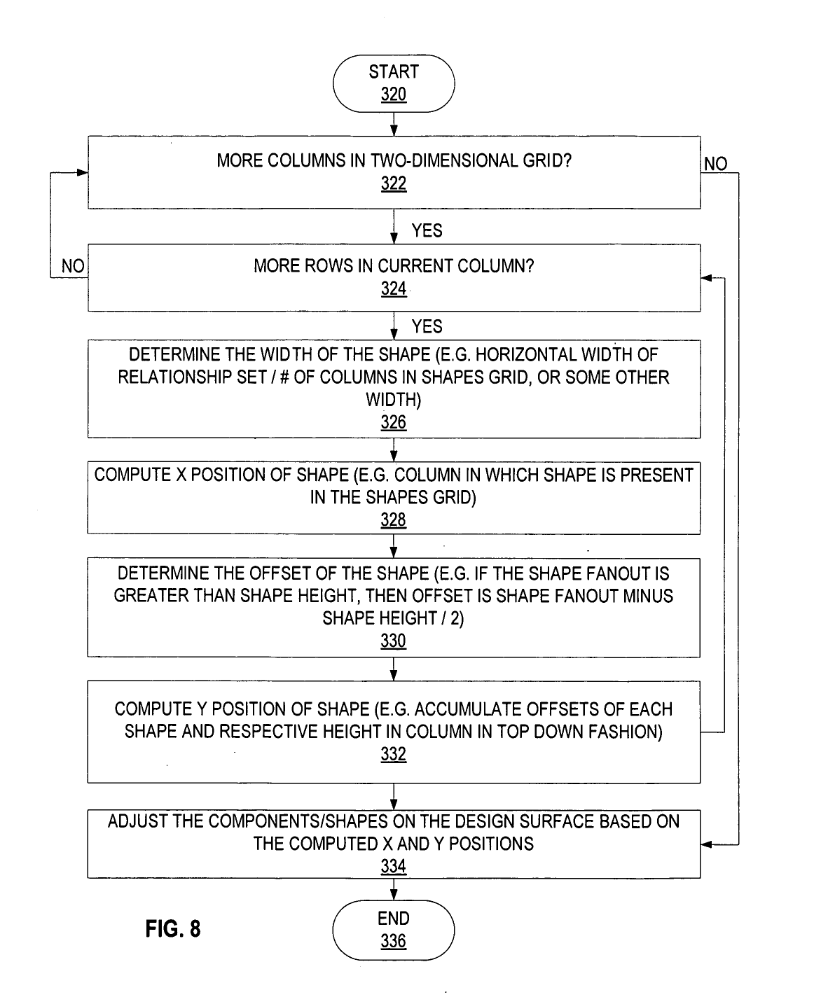

FIG. 8 illustrates one implementation of the stages involved in determining the placement positions for the shapes. In one form, the process of FIG. 8 is at least partially implemented in the operating logic of computing device 100. The procedure begins at start point 320 with performing a series of steps for each shape in the two-dimensional grid (decision points 322 and 322). The system determines the width of the shape (e.g. horizontal width of relationship set divided by # of columns in shapes grid, or some other width) (stage 326). The system computes the X and Y positions of the shape (stage 328). The system determines the offset of the shape (e.g. if the shape fanout is greater than shape height, then offset is shape fanout minus shape height divided by 2) (stage 330). The system also computes the Y position of the shape (e.g. accumulates offsets of each shape and respective height in column in a top down fashion) (stage 332). The system then adjusts the components/shapes on the design surface based on the computed X and Y positions (stage 324). The process ends at end point 336.

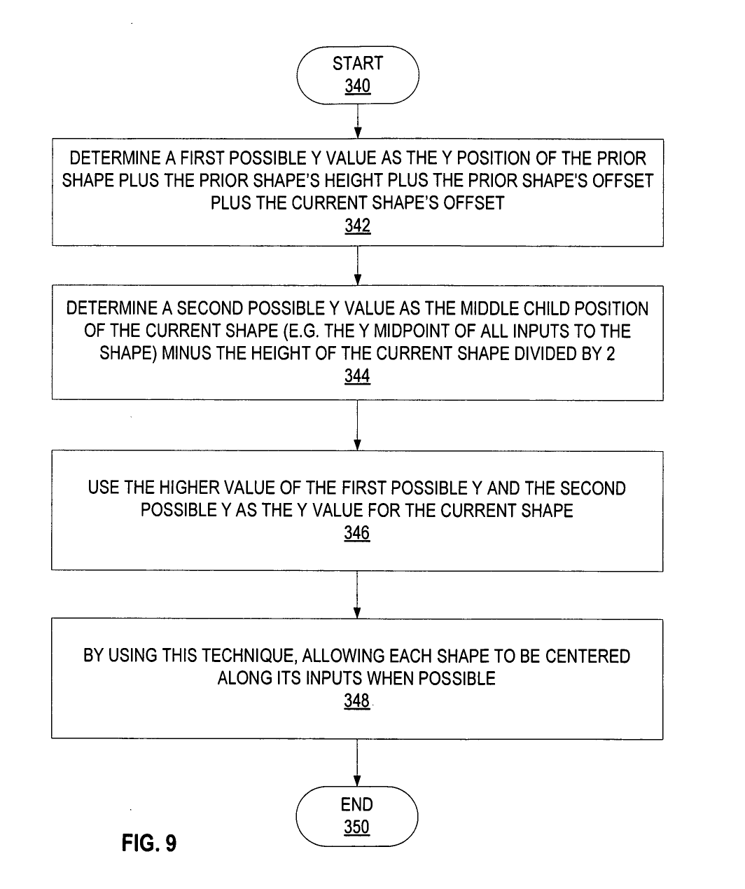

FIG. 9 illustrates one implementation of the stages involved in computing the Y position for one shape compared to another shape. In one form, the process of FIG. 9 is at least partially implemented in the operating logic of computing device 100. The procedure begins at start point 340 with determining a first possible Y value as the Y position of the prior shape plus the prior shape's height plus the prior shape's offset plus the current shape's offset (stage 342). The system determines a second possible Y value as the middle child position of the current shape (e.g. the y midpoint of all inputs to the shape) minus the height of the current shape divided by 2 (stage 344). In one implementation, the system uses the higher value of the first possible Y and the second possible Y as the Y value for the current shape (stage 346). By using this technique, each shape is centered along its inputs when possible (stage 348). The process ends at end point 350.

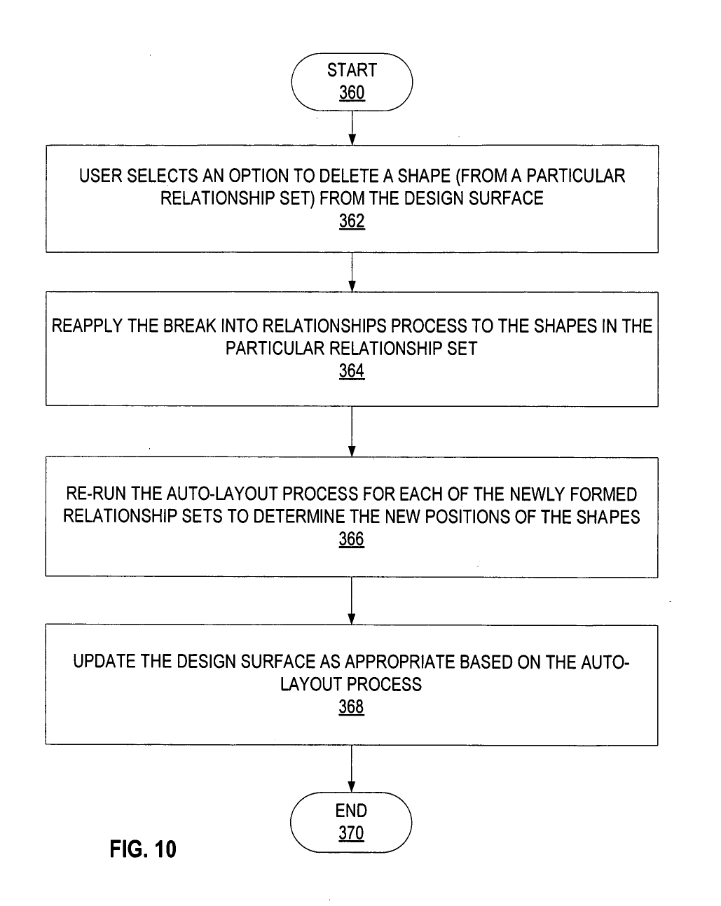

FIG. 10 illustrates one implementation of the stages involved in deleting a shape from a relationship set. In one form, the process of FIG. 10 is at least partially implemented in the operating logic of computing device 100. The procedure begins at start point 360 with the user selecting an option to delete a shape (from a particular relationship set) from the design surface (stage 362). The system reapplies the break into relationships process to the shapes in the particular relationship set (stage 364). The system re-runs the auto-layout process for each of the newly formed relationship sets to determine the new positions of the shapes (stage 366). The design surface is updated as appropriate based on the auto-layout process (stage 368). The process ends at end point 370.

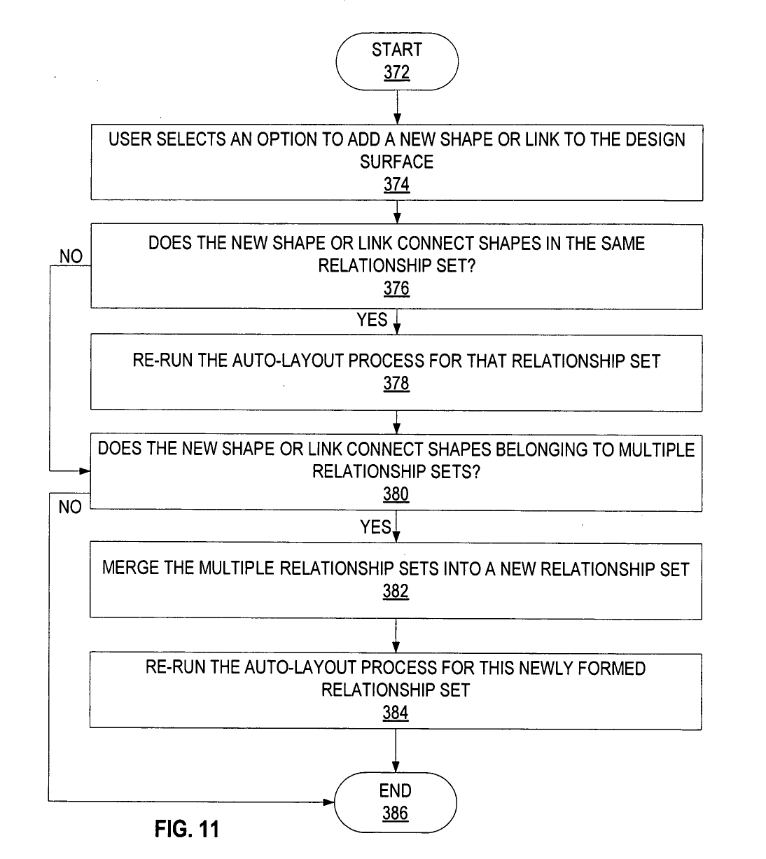

FIG. 11 illustrates one implementation of the stages involved in adding a new shape or link. In one form, the process of FIG. 11 is at least partially implemented in the operating logic of computing device 100. The procedure begins at start point 372 with the user selecting an option to add a new shape or link to the design surface (stage 374). If the new shape or link connects shapes in the same relationship set (decision point 376), then the system re-runs the auto-layout process for that relationship set (stage 378). If the new shape or link connects shapes belonging to multiple relationship sets (decision point 380), then the system merges the multiple relationship sets into a new relationship set (stage 382) and re-runs the auto-layout process for this newly formed relationship set (stage 384). The process ends at end point 386.

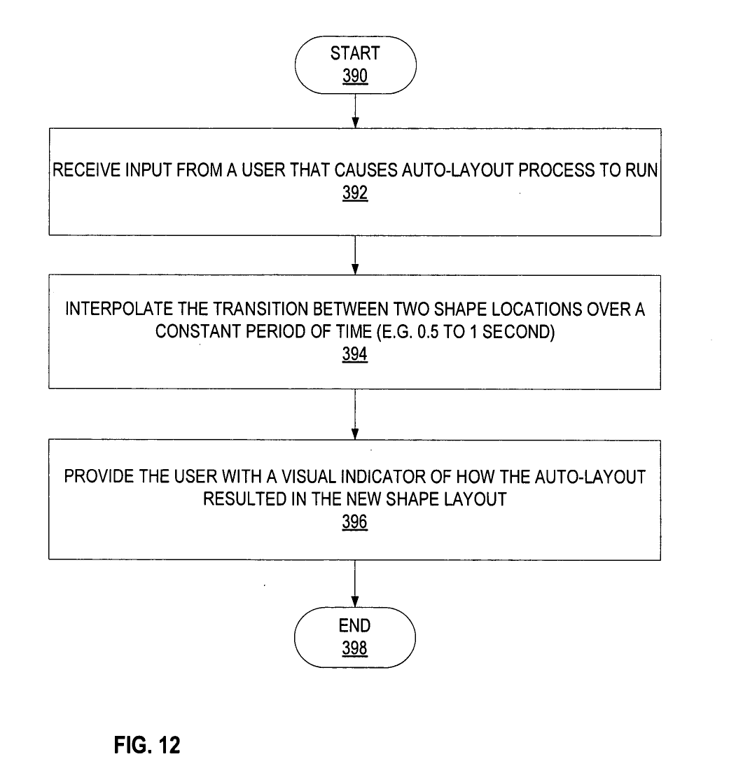

FIG. 12 illustrates one implementation of the stages involved in animating changes made on the design surface during the auto-layout process. In one form, the process of FIG. 12 is at least partially implemented in the operating logic of computing device 100. The procedure begins at start point 390 with receiving input from a user that causes the auto-layout process to run (stage 392). The system interpolates the transition between two shape locations over a constant period of time (e.g. 0.5 to 1 second) (stage 394) so the user is provided with a visual indication of how the auto-layout resulted in the new shape layout (stage 396). The process ends at end point 398.

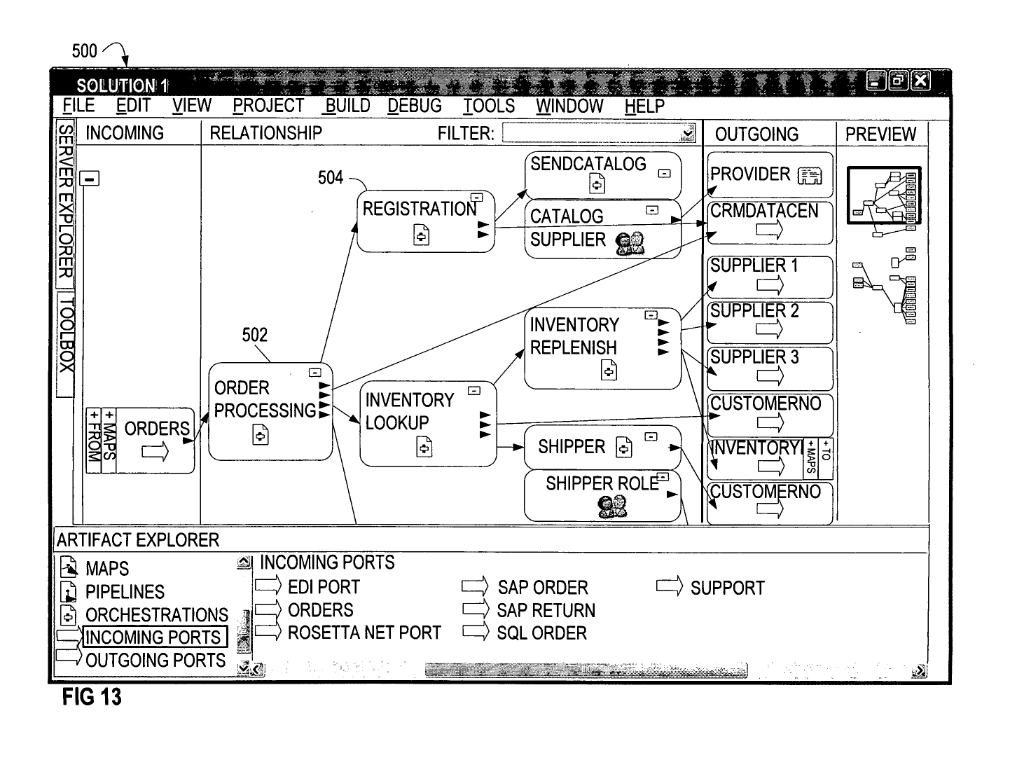

Turning now to FIG. 13-19, simulated screens and logical diagrams are shown to illustrate some of the concepts from the processes in FIG. 3-12 in further detail. FIG. 13 is a simulated screen 500 for one implementation of the system of FIG. 1 that illustrates a sample visual designer with a drawing that uses the auto-layout process.

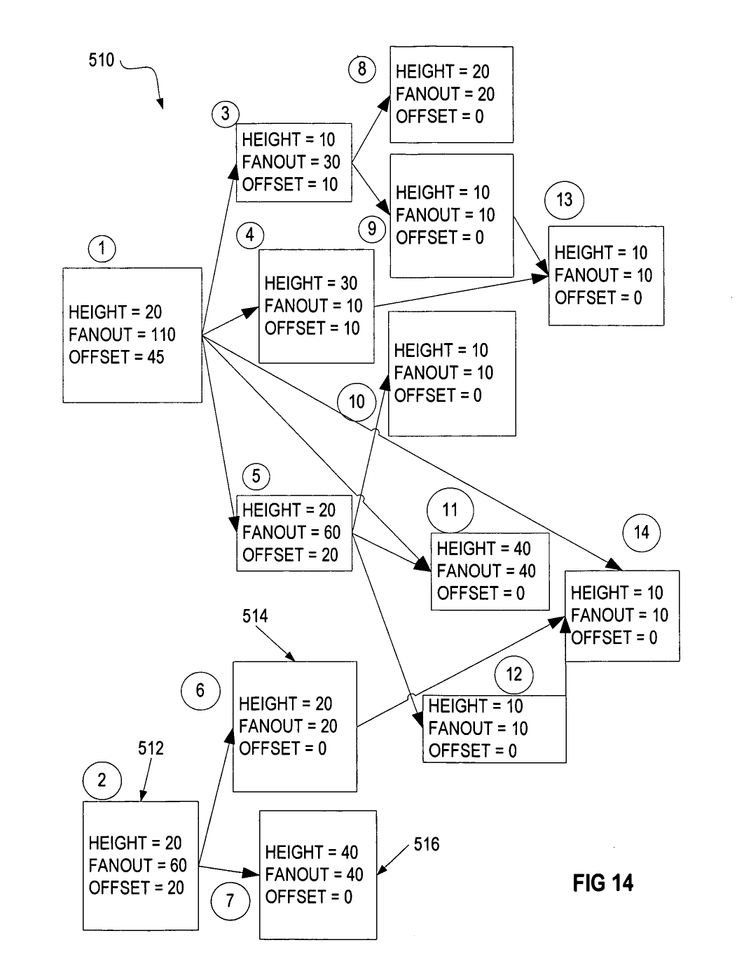

FIG. 14 is a logical diagram for one implementation of the system of FIG. 1 and process of FIGS. 6 and 7 that illustrates calculating height, fanout, and offset values for each component/shape to help determine new positions. Diagram 510 includes boxes that represent various components/shapes. The boxes contain a summary of the height, fanout, and offset values that have been calculated for the particular shape. These values are used to help make sure shapes do not collide with each other on the design surface. For example, the shape 2 is represented in box 512. It contains a height value of 20, a fanout value of 60, and an offset value of 20. The fanout value is the sum of its children, which in this case are the fanouts of box 514 (fanout=20) and box 516 (fanout=40).

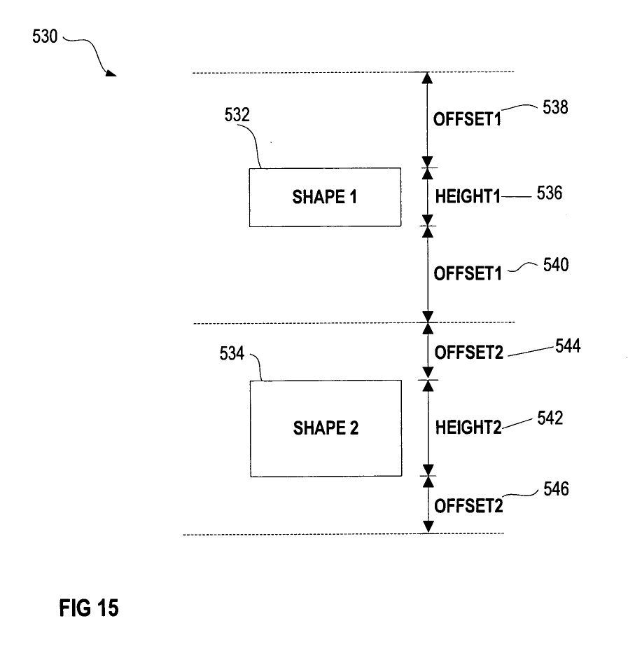

FIG. 15 is a logical diagram 530 for one implementation of the system of FIG. 1 that illustrates how height and offset values are calculated for a particular component/shape. Essentially every component/shape has an offset associated with it, and the same offset is allocated on either side of the shape. For example, if there are two consecutive shapes, shape1 (532) and shape2 (534) as shown in FIG. 15, and their corresponding offsets are offset1 (538 and 540) and offset2 (544 and 546), then these two shapes are separated apart by a distance of offset1 (538 and 540) plus offset2 (544 and 546). The offset corresponding to each shape is proportional to the total amount of fanout of that shape. In one implementation, if a shape has a large fanout, it means that this shape is the source for a large number of children and grand children. So this shape needs to be sufficiently away from its immediate consecutive shapes of the same column, so that a potential shape collision is avoided. Shape1 has a height1 (536) and shape2 has a height2 value (542) which are taken into consideration along with offsets in determining position. Ad described in FIG. 8, the offset of the shape is determined by the following calculation: if the shape fanout is greater than the shape height, then the offset is the shape fanout minus the shape height divided by two (stage 330).

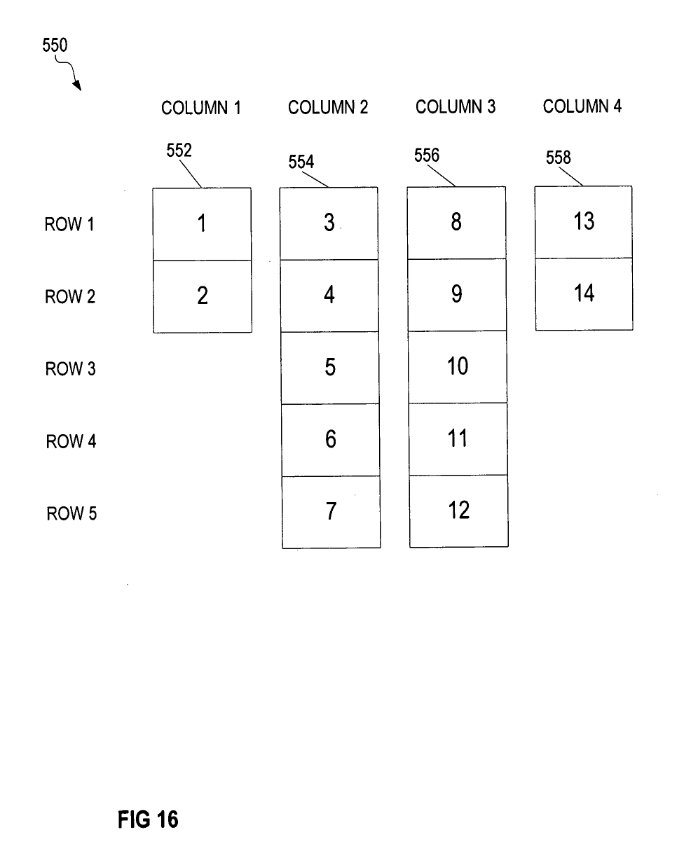

FIG. 16 is a logical diagram for one implementation of the system of FIG. 1 that illustrates a sample two-dimensional grid 550 filled with the components/shapes from FIG. 15 upon executing the auto-layout process according to the stages described in FIG. 7. This particular two-dimensional grid 550 has four columns: column 1 (552), column 2 (554), column 3 (556), and column 4 (558). However, it will be appreciated that in other implementations, more or fewer columns could also be used. The system determines a column for the shape by the maximum number of hops necessary to reach the shape from one of the starting shapes in the relationship set (stage 304). The system assigned each shape to a particular cell (row & column) in the two-dimensional grid based on the next available row and column combination that will hold the determined column (stage 306). This two-dimensional grid is later used by the system to compute the shape positions (stage 308).

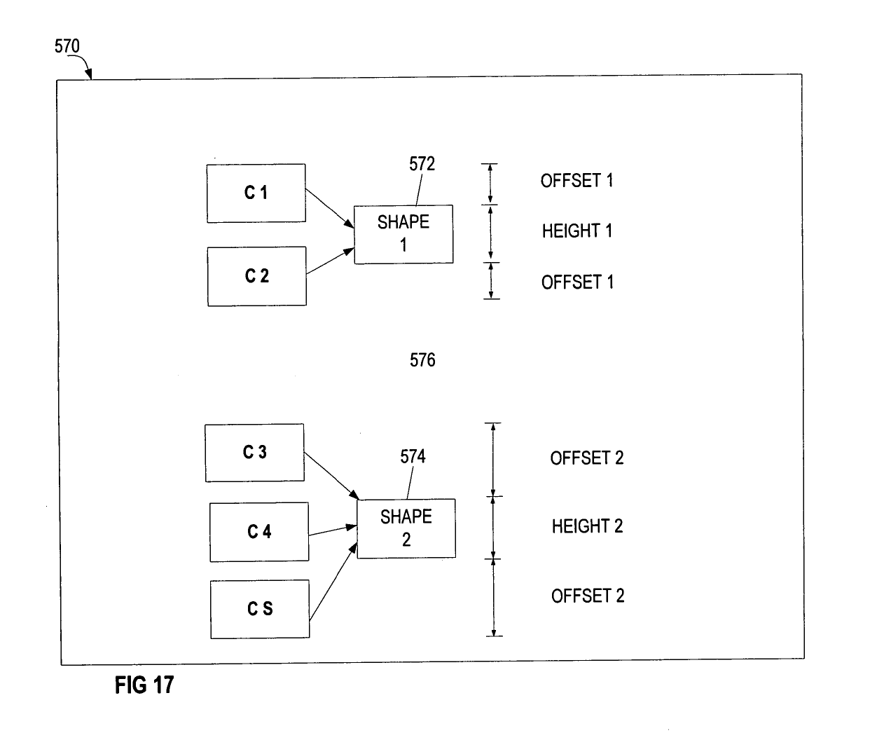

FIG. 17 is a logical diagram 570 for one implementation of the system of FIG. 1 that illustrates height and offset values for multiple shapes present together on a design surface. Shape 1 (572) and Shape 2 (574) have a fair amount of distance between them (576) because of the children they each have. The extra space (576) is provided to avoid too much crossing of lines and/or crowding of shapes.

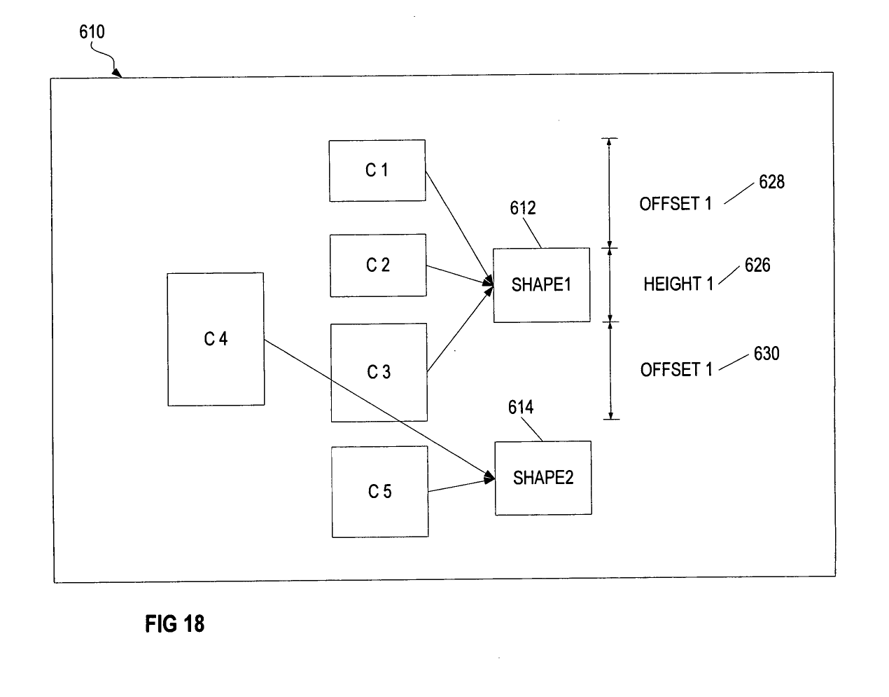

FIG. 18 is a logical diagram for one implementation of the system of FIG. 1 and the stages of FIG. 9 that illustrates using the offset and height values to determine the shape's Y position. As discussed in FIG. 9, in one implementation, Y1 is calculated as the Y position of the prior shape (612), plus the prior shape's height (626), plus the prior shape's offset (628 and 630), plus the current shape's offset (stage 342). Y2 is calculated as the middle child position of the current shape (e.g. the Y midpoint of all inputs to the shape) minus the height of the current shape divided by two (stage 344). Upon applying these formulas to FIG. 18, diagram 610 shows that for shape2 (614), Y1 is much greater than Y2. Thus, shape2 (614) is pushed down further in the column and is not centered on its children. In some instances, the shapes can get entangled and the links cross each other across two different columns. This can be avoided by sorting the shapes in the second column based on their middle child positions before attempting to determine the Y positions of the shapes for this second column.

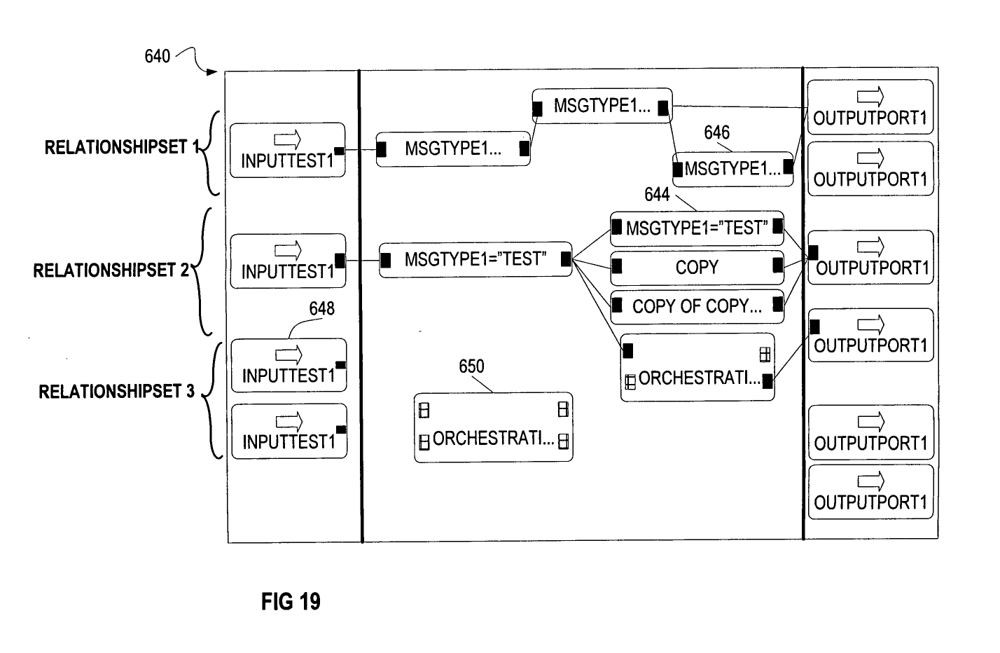

FIG. 19 is a portion of a simulated screen 640 for one implementation of the system of FIG. 1 that illustrates a diagram adjusted during the auto-layout process. Screen 640 has three relationships after the auto-layout process. In the example shown, the shapes in different relationship sets have different widths for different columns (e.g. 646 vs. 644). In addition, there are several orphan shapes illustrated on screen 640, such as orphan shapes 648 and 650. In the implementation shown in FIG. 19, orphans are shown as part of a separate relationship set. In another implementation, orphans can be shown in one of the columns of a particular relationship set that they may logically belong to.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A method for automatically laying out components comprising the steps of:
receiving input from a user to add a new component to a design surface, the design surface having a plurality of components that includes the new component;
programmatically analyzing at least a portion of the plurality of components according to a set of layout optimization rules, the layout optimization rules comprising:
assigning each of the at least the portion of components to a two-dimensional grid; and
using the two-dimensional grid to compute an X and Y position for each of the at least the portion of components;
analyzing the two-dimensional grid to determine if any of the components have a new X and Y position; and
adjusting a position for each component having the new X and Y position.

2. The method of claim 1, wherein a visual indicator is provided during the adjusting step so the user can see what changed.

3. The method of claim 1, wherein the visual indicator is an animation.

4. The method of claim 1, further comprising:
providing an undo feature to allow the user to undo the position adjustment.

5. The method of claim 1, wherein the analyzing step is initiated each time the user adds another component to the design surface.

6. The method of claim 1, wherein the analyzing step is initiated when the user selects an option to initiate an auto-layout process against an existing document.

7. A computer-readable medium having computer-executable instructions for causing a computer to perform the steps recited in claim 1.

8. A computer-readable medium having computer-executable instructions for causing a computer to perform steps comprising:
receive input from a user to add a new component to a design surface, the design surface having a plurality of components that includes the new component; and
upon receiving input from the user to add the new component, initiate an auto-layout process that analyzes at least a portion of the plurality of components according to a set of layout optimization rules and automatically adjusts a position for at least one of the components on the design surface.

9. The computer-readable medium of claim 8, wherein the analyzing at least a portion of the components according to the set of layout optimization rules comprises:
assigning each of the at least the portion of components to a two-dimensional grid; and
using the two-dimensional grid to compute an X and Y position for each of the at least the portion of components.

10. The computer-readable medium of claim 8, further causing a computer to perform steps comprising comprising:
when adjusting the position for the at least one component, provide a visual indicator to allow a user to see what changed on the design surface.

11. The computer-readable medium of claim 10, wherein the visual indicator provided is an animation.

12. The computer-readable medium of claim 8, further causing a computer to perform steps comprising:
provide an undo feature to allow the user to undo the position adjustment of the at least one component.

13. A method for automatically laying out shapes comprising the steps of:
initiating an auto-layout process to programmatically adjust a position of at least one shape on a design surface, the auto-layout process comprising the steps of:
assigning each shape to a particular cell in a two-dimensional grid;
traversing the two-dimensional grid one shape at a time and computing an X and Y coordinate for each shape; and
adjusting a position on the design surface for the at least one shape that has an X and Y coordinate that is different from a prior X and Y coordinate assigned to the at least one shape.

14. The method of claim 13, wherein the analyzing step is initiated each time the user adds another component to the design surface.

15. The method of claim 13, wherein the analyzing step is initiated when the user selects an option to initiate an auto-layout process against an existing document.

16. The method of claim 13, wherein a visual indicator is provided to allow a user to see that the position of the at least one shape was adjusted on the design surface.

17. The method of claim 16, wherein the visual indicator is an animation.

18. The method of claim 13, wherein an undo feature is provided to allow the user to undo the position adjustment.

19. The method of claim 13, wherein the Y position for each shape is calculated at least in part upon summing a shape height value with a shape offset accumulation value.

20. A computer-readable medium having computer-executable instructions for causing a computer to perform the steps recited in claim 13.
